(19) United States
(12) Patent Application Publication
(10) Pub. No.: US 2007/0115387 A1
(43) Pub. Date: May 24, 2007

(54) Underwater camera combination

(76) Inventor: Kenneth Kam-Sing Ho, Richmond (CA)

Correspondence Address: Kenneth Kam-Sing HO, Unit 105, 3830 Jacombs Road, Richmond, BC, V6V 1Y6, CA

(21) Appl. No.: 11/282,767

(22) Filed: Nov. 21, 2005

(51) Int. Cl. H04N 5/225

(52) U.S. Cl. 348/375

(57) ABSTRACT

There is disclosed a snug, form fitting skin for a camera to protect against trauma like dust, dirt, scratches and water. There is additionally disclosed a rigid housing for such skin-encased camera.

### FIELD OF THE INVENTION

This invention relates to cameras for underwater use.

### BACKGROUND OF THE INVENTION

This invention addresses some of the problems with diving with conventional digital cameras. Such problems relate to water and pressure.

SUMMARY OF THE INVENTION

There is provided a waterproof camera combination, comprising: (a) a camera with a plurality of function members, a viewing screen and a front lens; and (b) a synthetic skin that encases said camera by snugly fitting around said camera to provide a water-tight enclosure thereof and is of a thickness and elasticity to allow said functions buttons to be operated by a user pressing the corresponding portion of said skin.

### BRIEF DESCRIPTION OF THE DRAWINGS

All Figures herein are drawn for ease of explanation of the basic teachings of the present invention only; the extensions of the Figures with respect to number, position, relationship, and dimensions of the parts to form the preferred embodiment are explained or are within the skill of the art after the following teachings of the present invention have been read and understood. Further, the exact dimensions and dimensional proportions to conform to specific pressure, force, weight, strength, and similar requirements will likewise be within the skill of the art after the following teachings of the present invention have been read and understood. A better understanding of the present invention can be obtained when the following detailed description of the preferred embodiment is considered in conjunction with the following Figures, in which:

FIG. 1 is a front perspective view of a digital camera and a skin therefor according to this invention.

FIG. 2 is a back perspective view of the skin of FIG. 1.

FIG. 3 is a back perspective view of the skin with the back plate removed.

FIG. 4 is a back perspective view with a camera to be inserted into the skin.

FIG. 5 is a perspective view of the camera partially inserted into the skin.

FIG. 6 is another perspective view of the camera partially inserted into the skin.

FIG. 7 is a back perspective view of the skin-encased camera about to be inserted into its housing.

FIG. 8 is a back perspective view of the skin-encased camera inserted into the front portion of its housing.

FIG. 9 is three views of a spacer and dial actuator fitted within the skin.

FIG. 10 is three views of a spacer and slide actuator fitted within the skin.

### DETAILED DESCRIPTION OF THE PREFERRED EMBODIMENT

### Notice Regarding Copyrighted Material

A portion of the disclosure of this patent document contains material which is subject to copyright protection. The copyright owner has no objection to the facsimile reproduction by anyone of the patent document or the patent disclosure as it appears in the Patent and Trademark Office file or records, but otherwise reserves all copyright rights whatsoever.

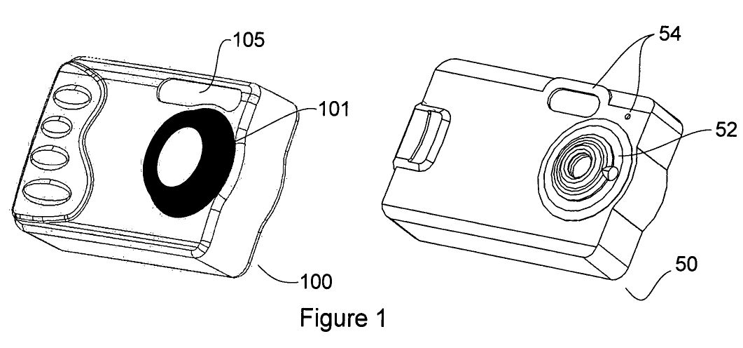

As seen in FIGS. 1 and 4-6, camera 50 is of a conventional digital type with a viewing window 51 (e.g. a LCD screen) for the user, front lens 52, and a plurality of camera function members generally identified as 53 and flash unit 54 (e.g. flash and red-eye reduction LED). Camera function members 53 include buttons to depress (e.g. shutter button, power button, four-way toggle) and members to rotate or slide (e.g. dial switch, jog dial, slider).

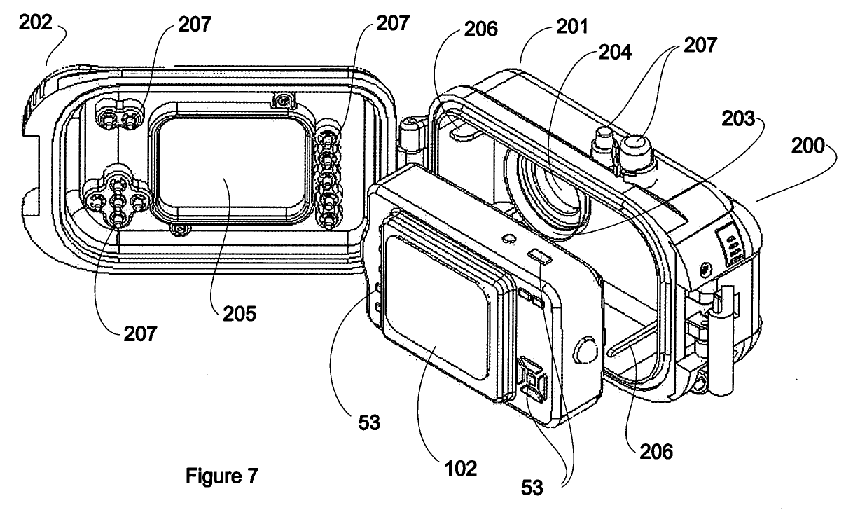

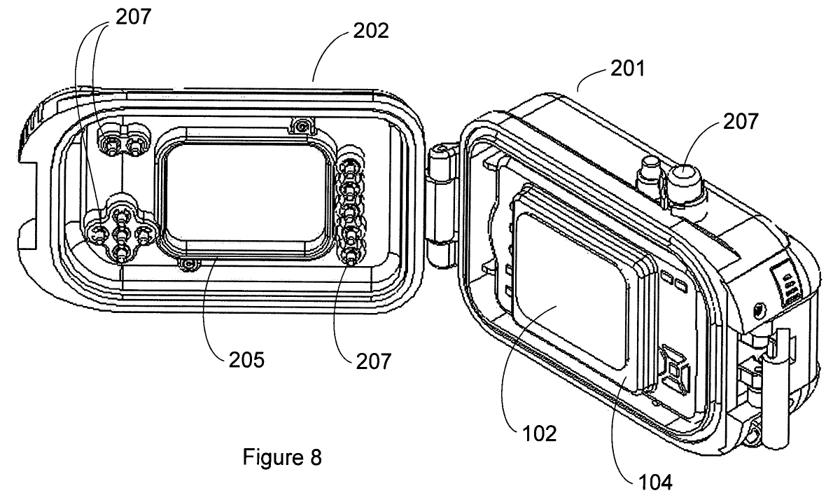

As seen in FIGS. 1-8, skin 100 is molded to provide a snug, form-fitting, “second skin” for encasing digital camera 50. Skin 100 is made of a synthetic, water-proof material (e.g. silicon rubber) and provides to camera 50 waterproofing and protection against sand, dirt, scratches. Skin 100 also provides to camera 50 (by itself or within housing 200, explained below) absorptive cushioning against minor impacts. Camera 50 fitted with skin 100 (as shown in FIGS. 7-8) is considered to be “skin-encased” and will be termed herein as an “encased camera”.

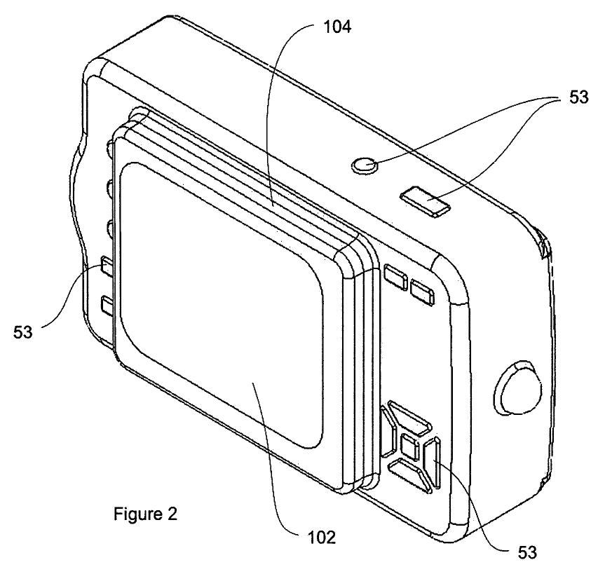

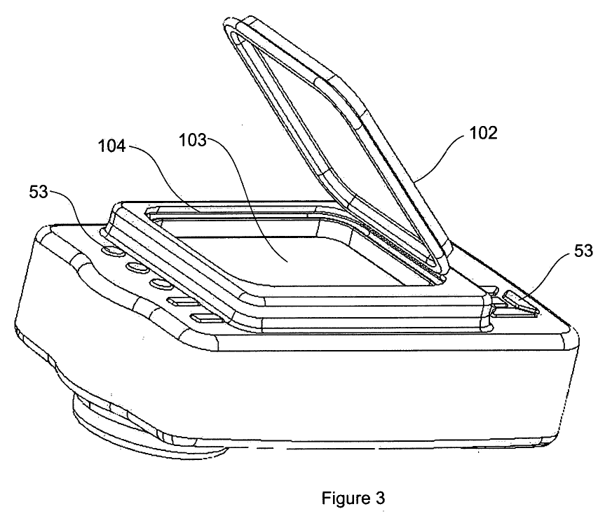

All the contours of camera 50 (e.g. finger grips, front lens 52, plurality of function members 53) are accommodated by skin 100 in a snug fit. Skin 100 is slightly thicker in some places (e.g. contour 104, explained below) and is sufficiently thin elsewhere to permit easy manipulation by the user of all key camera function members 53 by pressing the corresponding portion of skin 100 (and also by manipulation of, for example, spring-loaded buttons in another embodiment of this invention, as described below). Most clearly shown in FIGS. 2-3, portions of skin 100 may be raised slightly to accommodate camera function members which protrude slightly from camera 50.

Skin 100 has semi-rigid or rigid lens port 101 with tempered glass, to accommodate front lens 52 of camera 50 when encased.

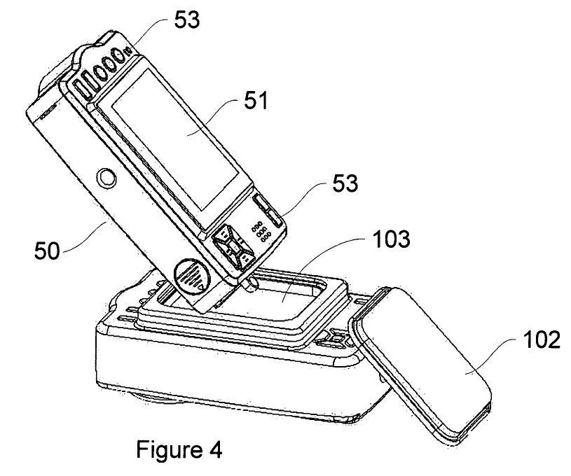

Skin 100 has a clear (e.g. acrylic) plate 102 that is positioned so as to provide the user a clear view of camera viewing window 51 when camera 50 is encased. Skin 100 has a hole 103 defined by a double-lipped, grooved contour 104 (best seen in FIG. 3) that insertably (and also removably) accepts and holds plate 102 into a water-tight friction fit, as seen in FIG. 2. Plate 102 and associated contoured hole 103 are dimensioned at least to permit the user a complete view of camera viewing window 51. Furthermore, plate 102 (and associated hole 103) should be of a size sufficient to permit camera 50 to be inserted therethrough completely so that camera 50 can be snugly fitted completely by skin 100 as a “second skin”, much like a diver dons a wetsuit, as seen in FIGS. 4-6). The “second skin” 100 can be removed (i.e. camera 50 is “un-encased”) by the reverse process, i.e. removing plate 102 from contoured hole 103, and then removing camera 50 through hole 103.

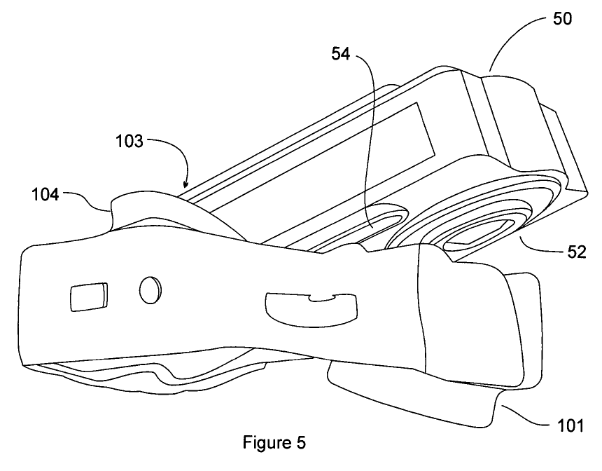

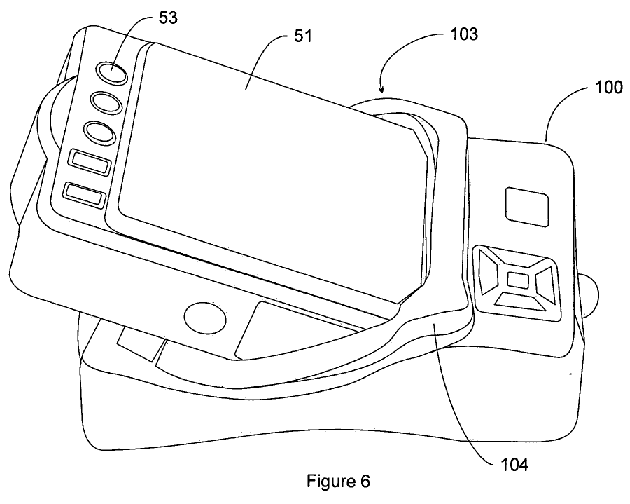

Skin 100 is made conventionally (by injection or compression molding) from conventional materials such as silicon rubber or other synthetic material of like properties. The average thickness of skin 100 is about 0.5 millimeters but as mentioned above, is thicker in some places and thinner in other places. Skin 100 must be flexible enough to permit (through pulling and stretching, as shown in FIGS. 5-6), the insertion of camera 50 into skin 100 through hole 103 and subsequent manual manipulation of camera 50 relative to skin 100 to conclude with the snugly fitting “second skin”, as described above.

Skin 100 may be transparent, translucent or coloured as desired (conventionally through the application of pigments in the skin molding process), with two advantageous exceptions. First, as seen in FIG. 1, skin 100 has a clear portion 105 for a flash from camera flash unit 54. Secondly, skin 100 is darkened around lens port 101 (as seen in FIG. 1, and not in other drawings for simplicity of presentation therein) to block the light that would otherwise travel from flash unit 54 through skin 100 and adversely affect the intake of light through camera lens 52.

Encased camera 50 is usable with aforementioned protections (against sand, dirt, scratching, moisture and like traumas) in a wide range of environments (e.g. in rough terrain or shallow water). For diving to greater depths with encased camera 50, there is provided rugged housing 200, as seen in FIGS. 7 and 8. Housing is made of two half shells or portions 201 (front) and 202 (back), hinged on one side and clampable tightly by conventional buckle-type clamping fasteners at the other side. Each half portion 201 and 202 can be formed as a molded product of synthetic resin (e.g. polycarbonate) or other synthetic material that is impermeable to water and resistant to pressure. Conventional O-ring or other sealing mechanisms are provided with half portions 201 and 202 so as to define a water-free space for encased camera 50 when half portions 201 and 202 are clamped closed.

Portion 201 has lens port 204 to accommodate lens port 101 of encased camera 50. Lens port 204 has an interior (of housing 200), inwardly and slightly opening cylindrical, semi-rigid plastic cowl or hood 203, as seen in FIG. 7. Hood 203 gently guides and accepts lens port 101 of encased camera 50 when front and back portions 201 and 202 are clamped closed. Hood 203 is dark to block light from camera flash unit 54 traveling through/along portion 201 of housing 200 if housing 200 is translucent or transparent, again to prevent adverse effects of such light on the proper intake of light into camera front lens 52. Hood 203 also assists in the moisture-sealing about lens port 101 when encased camera 50 is within clamped housing 200, by providing a plastic, sealing cushion for lens port 101 to abut against.

Portion 202 has an internal rectangular plastic ring or presser 205 positioned so that when encased camera 50 is placed within housing 200 and back portion 202 is clamped to front portion 201, presser 205 presses the perimeter of grooved contour 104 for urging a water-tight fit of plate 102 relative to hole 103.

As seen in FIGS. 7 and 8, webbing 206 and other infrastructures within housing 200 snugly receive, align and hold properly encased camera 50 relative to hood 203 and lens port 204, and relative to camera function actuators 207 (explained below).

The exterior of housing 200 has heavy-duty corner bumpers, finger/hand gripping surfaces for the ease of the diver, and other conventional members (not shown for simplicity of presentation in the drawings).

Camera function members 53 which are a depressible button have a corresponding actuator button 207 fitted on housing 200, conventionally spring-loaded and sealed against water intrusion, and perhaps ergonomically advantageous (e.g. oversized) for use by a diver underwater.

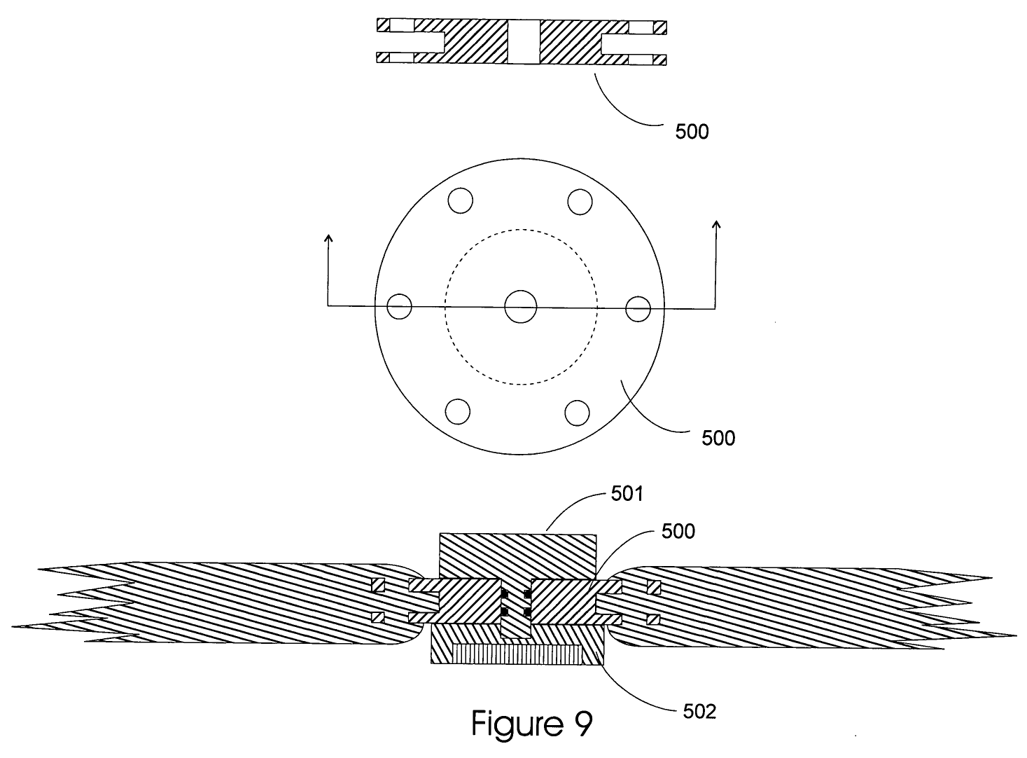

Camera function members 53 which are rotatable (e.g. dial) are rotated by the diver with following actuator. As seen in FIG. 9 (but not shown in the other drawings of skin 100 for simplicity of presentation), spacer 500 is lodged within skin 100, and rotatably houses a combination of external turning wheel 501 attached to internal cap 502 that friction fits against a dial button (not shown) of encased camera 50. Wheel and cap combination 501 and 502 are made of metal, stiff rubber or similar sufficiently rigid material.

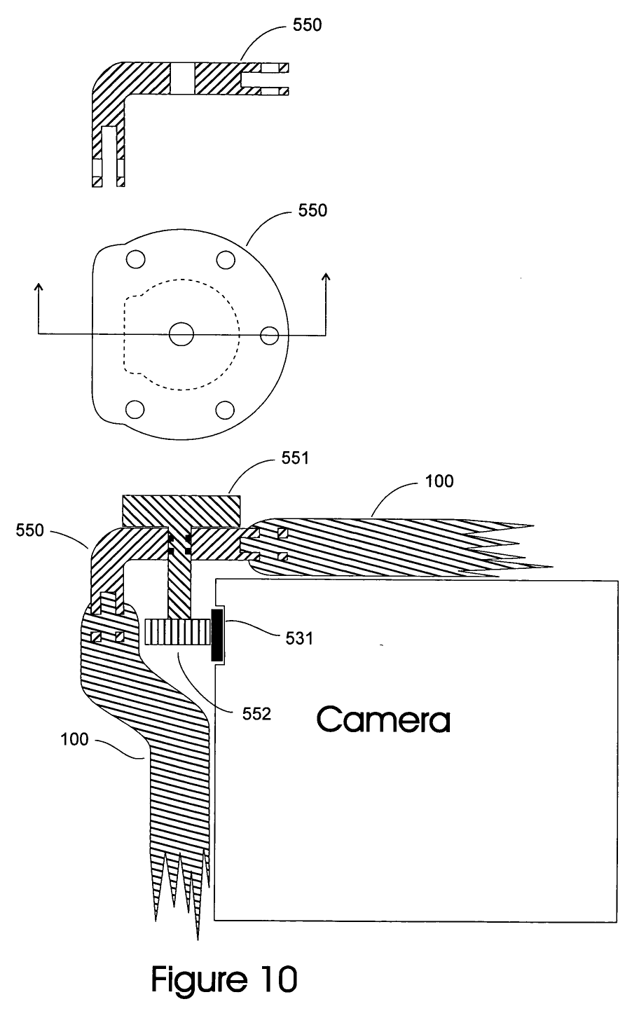

Camera function members 53 which are slidable, are slided by the diver with following actuator. As seen in FIG. 10 (but not shown in the other drawings of skin 100 for simplicity of presentation), spacer 550 is lodged at the corner of the top and side portions of skin 100 proximate a slide dial 531 of camera 50. Spacer 550 rotatably supports an external turning wheel 551 which turns a friction wheel 552 that abuts slide dial of 531 and laterally moves slide dial 531 in a pinion style interaction when wheel 551 is turned by the user.

Spacers 500 and 550 are “insert molded” into skin 100 as it itself is being molded. Spacers 500 and 550 can be made of metal or non-metallic material (such as thermoset plastic) as long as that material retains its shape (e.g. does not melt) in the temperature range that the silicon rubber is being molded. To make skin 100. The support provided by spacers 500 and 550 includes O-rings and other conventional mechanisms to resist water leakage.

Herein above, reference has been made to a “digital camera”, and a typical camera in terms of “form factor” representation has been illustrated in the Figures. This invention (and in particular, the skin and the housing thereof), are customizable to a wide range of cameras. Nothing herein is meant to limit this invention to a digital camera for still shots. For example, video cameras (or those having both still picture and video functionality) are within the teachings and spirit of this invention. Furthermore, skin 50 can be adapted for a wide range of cameras where the camera function members are operated by a depression, rotation or sliding movement. There might be some limitations for a camera where a very substantial projection must be accommodated (e.g. flash unit that pops up substantially or a lever switch that swings out substantially from the camera). But in these cases, skin 100 can be adapted to have a rigid or semi-rigid structure to accommodate the projection (e.g. along the lines of skin lens port 204 for lens port 101 of camera front lens 52).

One example of aforementioned adaptation is for cameras equipped with a zoom version of front lens 51. Skin 100 lens port 204 can be adapted by equipping it with a silicon skin bellows to surround the projected front lens 51 (not shown for simplicity of illustration) and which expands from an initial rest position and contracts, in response to the projection or retraction of the zoom lens.

Plate 102 made be of glass or transparent plastic but also may be made conventionally to provide a small magnification for the ease of the diver relative to camera viewing window 51.

Without skin 100, a camera within a housing like housing 200, would suffer from condensation and consequent damage to the electronics of the camera. Skin 100 provides protection against moisture condensation within housing 200.

Where used in the various figures of the drawings, the same numerals designate the same or similar parts. Furthermore, when the terms “top”, “bottom”, “first”, “second”, “inside”, “outside”, “edge”, “side”, “front”, “back”, “length”, “width”, “inner”, “outer”, and similar terms are used herein, it should be understood that these terms have reference only to the structure shown in the drawings as it would appear to a person viewing the drawings and are utilized only to facilitate describing the invention.

Although the method and apparatus of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

We claim:

1. A waterproof digital camera combination, comprising:
(a) a digital camera with a plurality of function members, a viewing screen and a front lens;
(b) a synthetic skin that encases said camera by snugly fitting around said camera to provide a water-tight enclosure thereof and is of a thickness and elasticity to allow said functions buttons to be operated by a user pressing the corresponding portion of said skin.

2. The combination of claim 1, wherein said skin has a lens port to accommodate said camera front lens.

3. The combination of claim 2, wherein said skin has a transparent portion corresponding to said viewing screen.

4. The combination of claim 3, wherein said skin transparent portion is a transparent plate that is removably inserted within said skin in a water-tight relationship therewith.

5. The combination of claim 4, wherein said skin transparent portion has a hole with a grooved perimeter for releasably accepting said transparent plate.

6. The combination of claim 5, wherein said skin transparent portion is dimensioned so that when said plate is removed, the camera can be inserted therethrough and removed therethrough.

7. The combination of claim 6, wherein one of said camera function members is a button operated by horizontal movement, and said skin has a member that is manipulable by the user for translating that manipulation, by a friction-fit, to said camera function button.

8. The combination of claim 7, wherein said camera function member is a rotatable dial.

9. The combination of claim 8, wherein said camera function member is a slide button.

10. The combination of claim 1, wherein said skin is colored.

11. The combination of claims 1, wherein said skin is darkly colored around said lens port (to reduce reflection from flash).

12. The combination of claim 11, further comprising a rigid, waterproof housing that accepts said digital camera encased by said skin.

13. The combination of claim 12, wherein said housing has means for actuating one of said camera function members.

14. The combination of claim 13, wherein said actuating means is a spring-loaded for depressing said one camera function member through said skin.

15. The combination of claim 14, wherein said housing comprises a front half portion and a back half portion that are hinged at one side and are releasably fastenable at the other side to create a water-tight seal.

16. The combination of claim 15, wherein said housing back half portion has a plastic ring that presses on said skin plate when said front and back half portions are fastened together, to ensure a water-tight fit.

17. The combination of claim 15, wherein said housing front half portion has a soft semi-rigid hood that accepts said camera lens port in a water-tight relationship.

18. The combination of claim 17, wherein said hood is dark.

19. The method of protecting a digital camera with a back viewing window, comprising the step of:
(a) encasing the camera with a snug, form-fitting silicon skin.

20. The method of claim 19, further comprising the further step of:
(b) providing said skin with a hole through which the camera can be inserted and later removed, and with a transparent plate to fill said hole in a water-tight relationship that aligns with said window back viewing window.
